(19) United States
(12) Patent Application Publication
(10) Pub. No.: US 2011/0047527 A1
(43) Pub. Date: Feb. 24, 2011

(54) Systems, Methods, and Apparatuses for Providing Computing Device Deployment Environments for Developing Applications

(75) Inventors: Terrance Joseph Bird, Byron, MN (US); David Neville Brown, Pewsey (GB); Evan Charles Harter, III, New York, NY (US)

Correspondence Address: DORSEY & WHITNEY LLP;INTELLECTUAL PROPERTY DEPARTMENT, SUITE 1500, 50 SOUTH SIXTH STREET, MINNEAPOLIS, MN, 55402-1498, US

(73) Assignee: Vacava, Inc., Rochester, MN (US)

(21) Appl. No.: 12/861,544

(22) Filed: Aug. 23, 2010

Related U.S. Application Data
(60) Provisional application No. 61/235,741, filed on Aug. 21, 2009.

(51) Int. Cl. G06F 9/445; G06F 9/44

(52) U.S. Cl. 717/107; 717/106; 717/168; 717/174

(57) ABSTRACT

Users access a deployment environment utilizing a browser. The deployment environment automatically creates an application based on user input and then deploys the created application in response to an indication from a user. Deployment may include providing an automatically generated reference. When an application is accessed via a browser utilizing such a reference, the deployment environment may execute and deliver access to the referenced application. In some implementations, the deployment environment may allow the user to choose between a wizard and a development tool. The wizard may present a series of prompts that guide the user through a default template for designing an application, which is then automatically created based on the user's responses. The development tool may include an interface where the user can select pre-assembled application components or customize such components for designing an application, which is then automatically created based on the user's selections and/or modifications.

### RELATED APPLICATIONS

The application claims priority under 35 U.S.C. §119(e) to U.S. Provisional Application Ser. No. 61/235,741, filed Aug. 21, 2009. which is herein incorporated by reference in its entirety.

### FIELD OF THE INVENTION

This invention relates generally to software applications, and more specifically to computing device deployment environments for developing applications.

### BACKGROUND

Businesses, large and small, around the world struggle with delivering flexible solutions quickly enough to adapt business processes to new ways of doing business. Simultaneously, businesses struggle with reducing costs, providing better customer service, and enabling business expansion. However, creation and deployment of business applications is generally time consuming and technically challenging. Typically, business people are the knowledge workers. They are the source for information and requirements about how business applications need to work and the functions such applications need to serve.

Unfortunately, business people generally do not have the technical expertise to develop and deploy the business applications. Often, business people have to rely on information technology people for development and deployment functions. This integration of business people and technical people for developing and deploying business applications, typically necessary to bring together the source of information and requirements with the necessary technical ability, consumes time and adds complexity to the creation of business applications. Further, development and deployment are typically performed by technical people with differing skill sets. Integrating the efforts of these disparate technical people adds additional complexity. As businesses increasingly need situational applications (e.g., software applications developed quickly to meet a specific business need) the time and complexity required for development and deployment may be prohibitive. As such, business users may not get the benefit of applications that could increase productivity, reduce costs, or otherwise help the business.

### SUMMARY

The present disclosure discusses systems, methods, and computer program products for providing deployment environments for quickly and simply developing and deploying software applications without the need for advanced technical expertise. A deployment environment is executed on a computing device. Users may access the deployment environment utilizing a browser to communicate requests related to the development of one or more software applications to the deployment environment. The deployment environment, in response to such requests, may automatically create the software application based on the user's input. The deployment environment may then deploy the created software application in response to an indication from the user. The deployment environment may deploy the application by providing the user with an automatically created reference (such as a uniform resource locator link, an iframe uniform resource locator, and so on) to the created software application. When such a created software application is accessed via a browser utilizing such a reference, the deployment environment may execute the created software application and deliver access to the created software application by receiving input for the executing software application from the browser as well as providing output for the executing software application to the browser.

In some implementations, the deployment environment may allow the user to choose between using a software application creation wizard and a development tool for designing and developing the software application. The software application creation wizard may present a series of prompts that guide the user through a default template for designing a software application, which is then automatically created based at the user's responses. The development tool may include an interface (such as a graphical user interface) where the user can select pre-assembled application components to construct the software application. Further, the development tool may provide the user the ability to customize one or more of the pre-assembled application components by adding in their own programming code, modifying the programming code of the pre-assembled components, and so on. The development tool may receive and collect selections made by the user and the deployment environment may then automatically create the software application based the user's selections and/or modifications.

It is to be understood that both the foregoing general description and the following detailed description are for purposes of example and explanation and do not necessarily limit the present disclosure. The accompanying drawings, which are incorporated in and constitute a part of the specification, illustrate subject matter of the disclosure. Together, the descriptions and the drawings serve to explain the principles of the disclosure.

### BRIEF DESCRIPTION OF THE DRAWINGS

FIG. 1 is a block diagram illustrating a system for developing and deploying software applications, in accordance with one or more implementations of the present disclosure; and

FIGS. 2A and 2B are a flow chart illustrating a method for developing and deploying software applications which may be performed by the system of FIG. 1.

### DETAILED DESCRIPTION OF THE EMBODIMENTS

The description that follows includes systems, methods, techniques, instruction sequences, and/or computer program products that embody techniques for implementing the present disclosure. However, it is understood that the described disclosure may be practiced without these specific details. Reference will now be made in detail to the subject matter disclosed, which is illustrated in the accompanying drawings.

The present disclosure describes computing device environments for quickly and simply developing and deploying software applications. The complexities associated with developing and deploying business applications are addressed herein by providing deployment environments which may be utilized to create, develop, and deploy software applications. As the same environment creates, develops, deploys, and executes the software applications, the complexity of development and deployment is reduced. For example, a user who develops and deploys a software application does not require advanced programming skills as the user can utilize components which have already been programmed and created to perform the functionality the user desires. By way of an additional example, a user is freed from addressing whether or not a developed application will be compatible with the eventual deployment mechanism as the same environment that is utilized to develop the software application also deploys the application. By way of still another example, a user is not required to configure servers to deploy a developed software application as the deployment environment is already configured to deploy the software application upon the user's specification. Thus, software applications may be developed and deployed without the need for advanced technical expertise.

Further, the deployment environment may include graphical user interfaces that provide software application creation wizards and/or development and deployment tools that include selectable pre-built application components corresponding to commonly utilized functionalities. By providing software application creation wizards that include a series of prompts for guiding users through default templates for development and deployment of software applications, even completely non-technical users may be able to develop and deploy software applications. Additionally, the ability to utilize development and deployment tools to graphically select pre-assembled application components may allow users with slightly more technical skill to incorporate various functionalities into software applications without having the increasingly advanced skills necessary to develop components to provide such functionalities. Moreover, such pre-assembled application components may be customized, allowing less technical users to develop and deploy the majority software applications while still enabling implementation of further advanced functionality through individual customization of pre-assembled component by technical personnel.

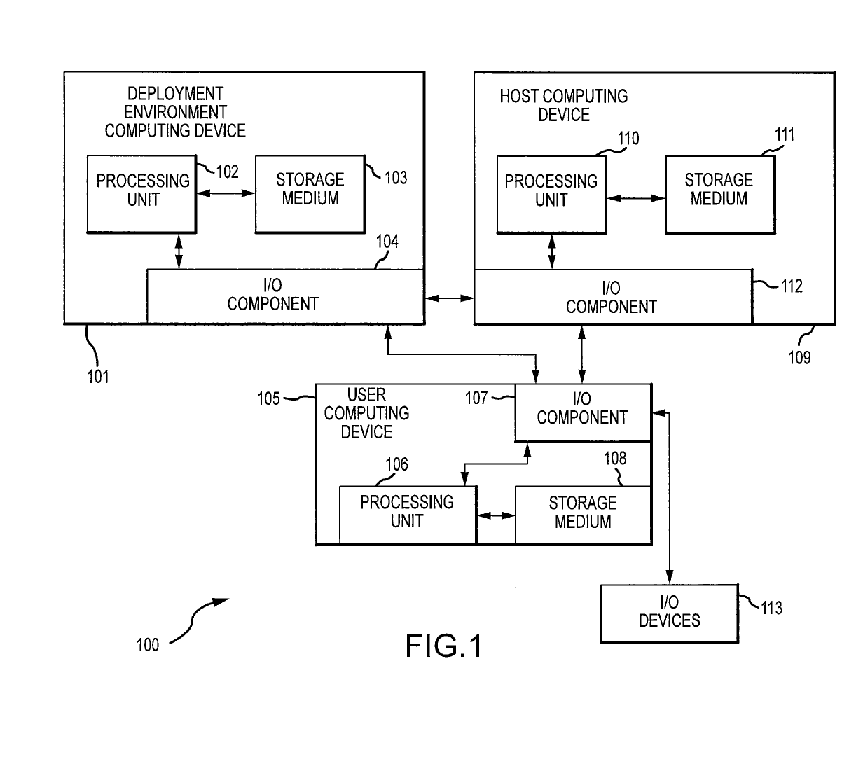

FIG. 1 is a block diagram illustrating a system 100 for developing and deploying software applications, in accordance with one or more implementations of the present disclosure. The system includes a deployment environment computing device 101 communicably connected (such as via a network connection) to a user computing device 102. The deployment environment computing device may provide the deployment environment of the present disclosure. The user computing device may be utilizable by one or more users to access the deployment environment and/or one or more software applications deployed by the deployment environment via the input/output component. The deployment environment computing device and the user computing device may each be any kind of computing device such as a server computing device, a desktop computing device, a laptop computing device, and so on. Further, although the deployment environment computing device and the user computing device are illustrated and described as single computing devices, in some implementations they may include multiple computing devices, such as computing devices arranged in a cloud configuration. Moreover, although they are illustrated and described as separate devices, in some implementations they may be incorporated into the same device.

The deployment environment computing device 101 includes one or more processing units 102, a tangible storage medium 103 (which may include any kind of non-transitory storage medium), and one or more input/output components 104 which may be coupled by one or more buses. The processing unit of the deployment environment computing device may execute instructions stored in the tangible medium to implement the deployment environment of the present disclosure. Additionally, the processing unit may execute instructions stored in the tangible medium to implement a browser (such as a web browser) that may one or more users may use to access the deployment environment and/or one or more software applications deployed by the deployment environment.

Similarly, the user computing device 105 includes one or more processing units 106, a tangible storage medium 108 (which may include any kind of non-transitory storage medium), and one or more input/output components 107, which may be coupled by one or more buses. The user computing device may also include one or more input/output devices 113, such as monitors, keyboards, mice, and so on, coupled to the input/output component 107. The processing unit of the user computing device may execute instructions stored in the tangible medium to implement a browser (which may be a web browser such as a Internet Explorer™ web browser, a Netscape™ web browser, a Mozilla™ web browser, a Firefox™ web browser, a Safari™ web browser, and so on) that one or more users may use to access the deployment environment and/or one or more software applications deployed by the deployment environment via the input/output component.

The deployment environment computing device 101 may execute a deployment environment. One or more users may access the deployment environment (via the input/output component 107 and the input/output component 104) utilizing a browser executing on the user computing device 105. The user may transmit input to the deployment environment and receive output from the deployment environment via the browser. In this way, the user may communicate requests related to the development of one or more software applications to the deployment environment. The deployment environment, in response to such requests, may automatically create the software application based at least one the user's input. Further, the deployment environment may deploy the created software application in response to an indication from the user that the created software application should be deployed.

The deployment environment may deploy the application by providing the user with an automatically created reference to the created software application (such as a uniform resource locator link, an iframe uniform resource locator, and so on) that can be utilized to access and execute the created software application within the deployment environment. For example, the deployment environment may provide access to applications via a world wide web address “www dot server dot com/deploymentevironment/”. As such, when the deployment environment creates a software application titled “addressbook”, the deployment environment may automatically generate a uniform resource locator of “www dot server dot com/deploymentevironment/addressbook.html” that may be utilized to access the created addressbook software application and provide the automatically generated link to the user. The user (and/or other users) may then access the created software application utilizing the reference via the browser of the user computing device 105 (and/or other user computing devices). When such a created software application is accessed utilizing such a reference, the deployment environment may execute the created software application and deliver access to the created software application by receiving input for the executing software application from the browser as well as providing output for the executing software application to the browser.

Subsequent to deployment of the created software application, one or more users may submit one or more requests to the deployment environment to modify the created software application. In response to receiving such requests, the deployment environment may be operable to modify the created software application such that future accesses to the created software application access the modified software application. The deployment environment may be operable to so modify the created software application without requiring redeployment.

Additionally, in some implementations the system 100 may also include a host computing device 109, which may be any kind of computing device and may include one or more processing units 110, a tangible storage medium 111, and one or more input/output components 112. The host computing device may be communicably coupled to the deployment environment computing device 101 and the user computing device 105 via one or more communication networks (such as a local area network or the Internet) and the processing unit of the host computing device may execute instructions stored in the tangible medium to implement a network host service to provide users with access to network resources (such as web pages or applications) over the communication network.

The network host service may be configured to access the reference (such as via a uniform resource locator link and/or an iframe uniform resource locator included in one or more web pages) in response to one or more requests received via a browser executing on a user computing device, such as the user computing device 105. Although the host computing device and the deployment environment computing device are shown and described as separate devices, in various implementations they may be incorporated into the same device.

To aid the user in communicating requests related to the development of a software application, the deployment environment may provide one or more software application creation wizards to the user. Such a wizard may present a series of prompts (such as a series of screens upon which the user can select various option) that guide the user through a default template for designing a software application. Such a default template may be based on frameworks of commonly utilized applications, such as the ability to enter data, store the entered data, modify the entered data, and view the entered data. The wizard may receive and collect responses that the user makes to the series of prompts and the deployment environment may then automatically create the software application based at least on the responses. The deployment environment may include modules which have been preprogrammed to perform various functions which the development environment may automatically link and customize based on the user's responses. For example, based on the above framework, the deployment environment may include database modules, screen modules for data entry and presentation, and interaction modules that enable interaction between the database modules and the data entry and presentation screen modules. Based on the user responses to the prompts, the deployment environment may automatically create the software application by creating or modifying one or more tables implemented in the database modules, creating or modifying one or more of the data entry and presentation screens implemented by the screen modules, configuring how the interaction modules enable interaction between the tables implemented in the database modules and the data entry and presentation screens, and so on. After the deployment environment creates the application, the deployment tool may allow the user to deploy the application by selecting a single selection element, such as graphically checking a deploy check box.

Additionally, the deployment environment may provide one or more development tools to the user to aid that user in communicating requests related to the development of a software application. Such a development tool may include an interface (such as a graphical user interface) where the user can select pre-assembled application components to construct the software application. The pre-assembled components may be pre-programmed modules which perform different functionalities that may be utilized in a software application. The functionality that may be performed by a software application may be limited to the functionality which modules corresponding to pre-assembled components provided by the development environment have been pre-programmed to perform. The development tool may receive and collect selections made by the user and the deployment environment may then automatically create the software application based at least on the selections by modifying and linking the various modules corresponding to the selected pre-assembled application components as specified by the user.

Further, the development tool may provide the user the ability to customize one or more of the pre-assembled application components by adding in their own programming code, modifying the programming code of the pre-assembled components, and so on. To provide the user the ability to customize pre-assembled components and so on, the development tool may provide compilers or interpreters as well as information regarding how to integrate user programming code with the pre-defined components (such as application programming interfaces specifying data of the pre-defined components, how to interact with that data, and so on). The development tool may also provide the user with the ability to add and utilize interfaces (such as application programming interfaces) to other applications whether inside or outside of the deployment environment (such as Google™ Apps). If the user utilizes the development tool to customize the one or more pre-assembled application components, the deployment environment may include the customizations (including any programming code received from the user) when creating the software application. When including customizations, the deployment environment may utilize one or more compilers, interpreters, linkers, and so on to verify that the user programming code is syntactically correct, correctly accesses data of other modules corresponding to selected pre-assembled application components, and so on. If the deployment environment cannot verify the user programming code, the deployment environment may provide one or more error messages to the user regarding the failed verification. After the deployment environment creates the application, the deployment tool may allow the user to deploy the application by selecting a single selection element, such as graphically checking a deploy check box.

In various implementations, the deployment environment may present a user with a choice as to whether to use a software application creation wizard or a development tool when the user selects to create a software application. However, in various other implementations the deployment environment may default to either a software application creation wizard or a development tool or only one of the two may be made available to the user.

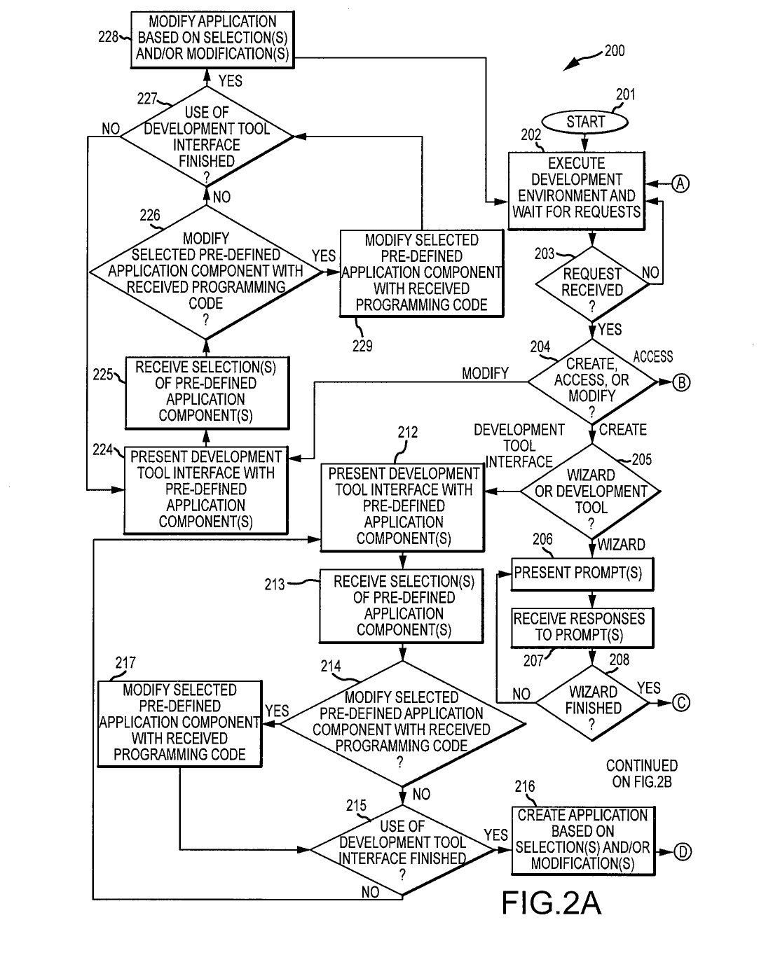

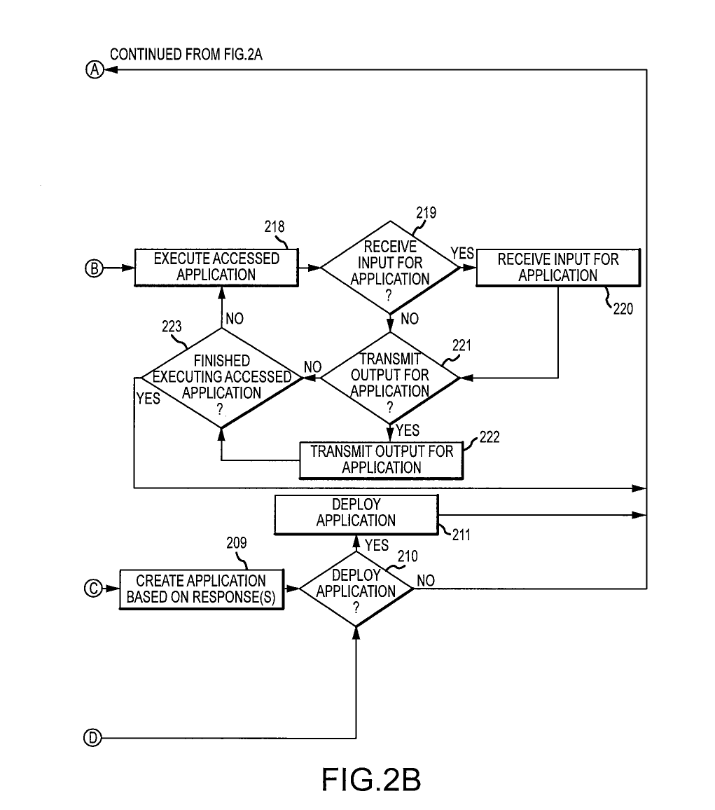

FIGS. 2A and 2B are a flow chart illustrating a method 200 for developing and deploying applications. The method 200 may be performed by the system 100 of FIG. 1. The flow starts at block 201 and proceeds to block 202. At block 202, the deployment environment computing device 101 executes the deployment environment and waits for requests. The flow then proceeds to block 203 where the deployment environment determines whether a request has been received. If a request has been received, the flow proceeds to block 204. Otherwise, the flow returns to block 202 to wait for requests to be received. At block 204, the deployment environment determines whether the received request is a request to create a software application, a request to access a software application, or a request to modify a software application. If the request is to create a software application, the flow proceeds to block 205. If the request is to access a software application, the flow proceeds to block 218. If the request is to modify a software application, the flow proceeds to block 224.

At block 205, after a request to create a software application has been received, the deployment environment determines whether to utilize a wizard or a development tool to create the software application. If the deployment environment will use a wizard to create the software application, the flow proceeds to block 206. Otherwise, the flow proceeds to block 212.

At block 206, after determining to utilize a wizard to create the software application, the deployment environment presents one or more prompts related to the wizard and the flow proceeds to block 207. At block 207, the deployment environment receives responses to the prompts. The flow then proceeds to block 208 where the deployment environment determines whether the wizard is finished. If the wizard is not finished, the flow returns to block 206. Otherwise, the flow proceeds to block 209.

At block 209, the deployment environment automatically creates the software application at least based on the responses to the prompts. The flow then proceeds to block 210 where the deployment environment determines whether to deploy the created software application. At block 210, if the created software application is to be deployed, the flow proceeds to block 211 where the deployment environment deploys the created software application. The flow then returns to block 202 where the deployment environment waits for additional requests to be received. However, if the created software application is not to be deployed, the flow returns from block 210 to block 202 where the deployment environment waits for additional requests to be received.

At block 212, after determining to utilize a development tool to create the software application, the deployment environment presents a development tool interface that includes selectable pre-defined application components and the flow proceeds to block 213. At block 213, the deployment environment receives selections of the pre-defined application components. The flow then proceeds to block 214 where the deployment environment determines whether to modify any of the selected pre-defined application components with programming code received from a user. If so, the flow proceeds to block 217 where the deployment environment modifies the selected pre-defined application components with the received programming code before proceeding to block 215. If not, the flow proceeds from block 214 to block 215. At block 215, the deployment environment determines whether the development tool is finished. If the development tool is not finished, the flow returns to block 212. Otherwise, the flow proceeds to block 216. At block 216, the deployment environment automatically creates the software application at least based on the selections and/or modifications. The flow then proceeds to block 210 where the deployment environment determines whether to deploy the created software application.

At block 218, after the deployment environment receives a request to access a software application, the deployment environment executes the accessed software application and the flow proceeds to block 219. At block 219 the deployment environment determines whether there is input to receive for the accessed software application. If so, the flow proceeds to block 220 where the input is received before the flow proceeds to block 221. If not, the flow proceeds to block 221 where the deployment environment determines whether there is output to transmit for the accessed software application. If so, the flow proceeds to block 222 where the output is transmitted before the flow proceeds to block 223. If not, the flow proceeds to block 223 where the deployment environment determines whether execution of the accessed software application is finished. If so, the flow returns to block 202 where the deployment environment waits for additional requests to be received. If not, the flow returns to block 218 and continues to execute the accessed software application.

At block 224, after the deployment environment receives a request to modify a software application, the deployment environment presents a development tool interface that includes selectable pre-defined application components and the flow proceeds to block 225. At block 225, the deployment environment receives selections of the pre-defined application components. The flow then proceeds to block 226 where the deployment environment determines whether to modify any of the selected pre-defined application components with programming code received from a user. If so, the flow proceeds to block 229 where the deployment environment modifies the selected pre-defined application components with the received programming code before proceeding to block 227. If not, the flow proceeds from block 226 to block 227.

At block 227, the deployment environment determines whether the development tool is finished. If the development tool is not finished, the flow returns to block 224. Otherwise, the flow proceeds to block 228. At block 228, the deployment environment modifies the software application at least based on the selections and/or modifications. The flow then returns to block 202 where the deployment environment waits for additional requests to be received.

The software application creation wizard that may be provided by the deployment environment will now be discussed in detail. In one example, the software application creation wizard may assume a default template that most software applications require three basic view: a data entry view, a data access view, and an administration view. For creating software applications that include these three views, the deployment environment may include database modules, screen modules for data entry and presentation, and interaction modules that enable interaction between the database modules and the data entry and presentation screen modules. The software application creation wizard may guide a user through creation of a software application that includes these three views.

The software application creation wizard may provide a first screen where users can enter each item of information that they wish to collect as well, the data type of that information, the method by which to collect that information (radio buttons, drop down menus, text boxes, and so on), and whether that information is mandatory. A user may be able to add the specified information item by selecting a button indicating to add that information item. The software application creation wizard may then provide a second screen where a user can specify different security options, such as who can enter data, view data, and administer data. The software application creation wizard may also present a confirmation screen where the user can verify that their responses thus far have been correct. If the user confirms, the wizard may present a arrangement screen that illustrates a default arrangement of data entry elements for the information items specified by the user. The user may be able to drag and drop the data entry elements to rearrange them on the arrangement screen.

The user may then be able to select to end the software application creation wizard, automatically creating the software application based on the provided responses and deploying the created software application. In automatically creating the software application, the deployment environment may create or modify one or more tables implemented in the database modules based on the responses, create or modify one or more of the data entry and presentation screens implemented by the screen modules based on the user responses, configure how the interaction modules enable interaction between the tables implemented in the database modules and the data entry and presentation screens based on the responses, and so on.

For example, a user may utilize the above software application wizard to create an address book application. On the first screen the user may specify that they wish to collect a name, a phone number, and an email address. The user may specify on the first screen that the name is a text value, the phone number is a number value, and the email address is an email. On the second screen the user may specify that anyone who accesses the application is allowed to enter data, view data, and/or administer data. On the arrangement screen the user may be presented with a default arrangement of a name box, phone number box, an email address box, and a button to submit entered data. The user may drag and drop to rearrange and/or resize the boxes on the screen from the default arrangement. Then, the user may select to end the software application wizard. In response, the associated development environment may automatically create the address book application by creating tables implemented in database modules corresponding to the text boxes, create appropriate a data entry/data presentation/data administration screens from the rearranged arrangement screen, and configure how the interaction modules enable interaction between the created tables and presentation screens.

It should be understood that the above described software application creation wizard is for the purposes of example only. Such a software application creation wizard may include any variety of numbers of prompts which may each prompt for a variety of responses.

The development tool that may be provided by the deployment environment will now be discussed in detail. The development tool may include a graphical interface, which may be a WYSIWYG (what you see is what you get) editor that provides a plurality of controls (such as buttons, drag and drop elements, menu bars, etc.) that a user can utilize to create and customize one or more screens for a software application. For example, the controls may be utilizable by the user to add or customize elements of a software application the user is creating or modifying. These elements include, but are not limited to, text (inputting and/or formatting), graphical elements (inserting and/or modifying), browser based form controls (fields, buttons, etc.), HTML (hypertext markup language) layout controls (frames, iFrames, in-line positioning, etc.), JavaScript functions and routines, cascading styles sheets, dynamic HTML, database tables and appropriate mapping, multiple or single screens, calls and links to programs and data sources external to the deployment environment (application programming interfaces, web services, etc.), and/or pre-defined functional elements (such as database views and interface objects). The interface objects included in the pre-defined functional elements that the user may add or customize for their software application may be components of software modules pre-developed to provide commonly utilized functionality for software applications. These commonly utilized functionalities may include, but are not limited to views of database tables, customer information, order management, quotation production, product information, shopping cart functionality, and/or help desk/product returns. The user may be limited to functionalities for which modules have been pre-programmed unless they develop additional modules to provide additional functionality. However, by utilizing pre-built components that provide commonly utilized functionality, a user is able to incorporate these functionalities into their software application without having to construct components to provide such functionalities.

The controls may allow a user to create one or more database tables that are stored within the deployment environment (and may be accessible by other applications developed within the deployment environment) and map those database tables to elements of the software application the user is creating or modifying. The controls may also allow a user to link the user's software application to other software applications existing within the deployment environment. Thus, in creating or modifying an application, a user may include any or all of the following: text (stylized, bolded, italicized, color, etc.), HTML form objects (text fields, radio buttons, combo boxes, check boxes, text areas, etc.), HTML positioning elements (in-line, tables, etc.), CSS (for object style, positioning, and etc.), Javascript, one or more database tables stored within the deployment environment, links to database tables external to the deployment environment, fields linked to either or both of the internal and external database tables, views (single table or joined) linked to either or both of the internal and external tables, and/or calls to other programs (application programming interfaces, web services, command line calls, etc.).

The development tool may also include one or more compilers, interpreters, specification documents, and so on. These provided compilers, interpreters, may enable the user to customize one or more of the pre-assembled application components by adding in their own programming code, modifying the programming code of the pre-assembled components, and so on. The specification documents may describe how to integrate user programming code with the pre-defined components. For example, the specification documents may list and describe application programming interfaces which specify data utilized by the pre-defined components, appropriate methods of interacting with that data, and so on. When the deployment environment automatically creates the software application, the deployment environment may modify and link the various modules corresponding to the selected pre-assembled application components and any user created or modified components as specified by the user. When including user created or customized components, the deployment environment may utilize one or more compilers, interpreters, linkers, and so on to verify and build the components. If the deployment environment cannot verify the user created or modified component, the deployment environment may provide one or more error messages to the user regarding the failed verification.

By utilizing the controls included in the graphical interface, a business user may be able to develop applications without having technical programming ability. However, a business user may cooperate with one or more technical users to add or modify the software application to include enhanced functionality utilizing programming related aspects such as JavaScript and/or calls to other programs. In this situation, a business user may be able to develop the majority of the application without requiring assistance from technical users and may utilize the assistance of the technical user on the aspects including the enhanced functionality that requires programming ability.

After a user has created or modified a software application, the deployment environment is operable to receive an indication from the user to deploy the created software application. The indication from the user to deploy the created software application may constitute an action such as the user clicking a button or radio button operable to execute instructions to deploy the created software application. Thus, a business user may also deploy a created software application in addition to being able to create and modify a software application without requiring programming knowledge.

After the deployment environment has received an indication from a user to deploy the software application, the deployment environment may provide access to the created software application upon receiving a request that utilizes the provided reference. The deployment environment may require accessing users to authenticate themselves before the deployment environment will provide access to the software application. In addition, the deployment environment may require authentication if the created software application was configured to require authentication by the user who created it. If authentication is required, the deployment environment may provide multiple levels of permissions such that different users may be granted access to certain aspects of the created software application and denied access to others. For example, some users may be granted the ability to only access the application to enter data whereas other users may be granted the ability to access and read data. Further, still other users may be granted the ability to access and read data and administer the created software application.

Once deployed, the deployment environment may provide an automatically generated application network address that may be utilized to access the created software application. Such an automatically generated application network address may be a combination of a network address of the computing device that the deployment environment executes upon, an identifier that identifies the deployment environment to the computing device, and an identifier that identifies the created software application to the deployment environment. For example, the automatically generated application network address may be an internet protocol (IP) address that includes the IP address of the computing device that the deployment environment executes upon, a port number associated with the deployment environment, and a name of the created software application. A user may then make the automatically generated application network address available to other users by sending it to them directly, or incorporating it into a network resource (such as a link or an iFrame in a web page).

Alternatively, the deployment environment may provide access to various software applications that have been created and stored within the deployment environment. For example, the deployment environment may provide a list of available created software applications to authorized users who have connected to the deployment environment and the users may access the available created software applications by selecting them from the provided list. Thus, various users may utilize the deployment environment to access the application.

Moreover, the deployment environment may provide access for creating, modifying, and accessing software applications as a pay service. The deployment environment may refuse access by a user if that user has not paid a fee. Alternatively, the deployment environment may provide a portion of possible functionality to a user who has not paid a fee and may only provide the remaining possible functionality upon payment by that user. For example, an unpaid user may be able to access the deployment environment to create a software application, but may not be able to deploy the created software application until that user has paid the fee. In other examples, the unpaid user may be able to create and deploy software applications, but may not be able to utilize advanced features such as granular security, particular development tools, unlimited storage space for created software applications, unlimited simultaneous access to created software applications, and so on.

As software applications are designed and developed using the same computing device and deployment environment that is used to deploy them, development and deployment may be compatible. Thus, the deployment environment may be utilized to drive both the interface for creating and/or modifying applications as well as deployment of the finished software application. The deployment environment may serve both the interface and the deployed software application to users' browsers, which may provide uniformity and commonality between the development and deployment sides. As the software application is being designed and developed, respective HTML, associated files, databases, and folder structure required by the deployment environment for deployment may be created and organized in the deployment environment. Therefore, when a user is ready to deploy the created software application, the components required may be available. This may include unique application network addresses to allow embedding of the created software application in other hosted services (such as web sites) as well as direct access to the created software application through the deployment environment.

Additionally, the deployment environment may include a rules engine that stores and checks one or more rules. When a created software application stored within the deployment environment is accessed, the rules engine may check to see if the access corresponds to one or more rules. If the access corresponds to one or more rules, the deployment environment may perform one or more actions. For example, the deployment environment may set or clear a flag in a database, send an alert (such as an email), alter data in a database, call another application stored in the deployment environment, or perform other types of actions. The one or more rules may have been created by the user(s) who(m) created one or more software applications stored in the deployment environment.

By way of example, a user may have created a software application where other users can register for an electronic newsletter by entering their names into data field. The user may have created this newsletter specifically to capture the attention of another user named “Frank Lloyd” and may want to be alerted if Frank Lloyd utilizes the software application to register for the newsletter. When the user created the registration software application, the user may have created a rule that specified that they be emailed if anyone entered the name “Frank Lloyd” into that specific data field. The deployment environment may then check this rule when an access occurs and if the access is the entry of “Frank Lloyd” into that specific data field, the deployment environment may send an email notifying the specified user of that occurrence.

In the present disclosure, the methods disclosed may be implemented as sets of instructions or software readable by a device. Further, it is understood that the specific order or hierarchy of steps in the methods disclosed are examples of exemplary approaches. Based upon design preferences, it is understood that the specific order or hierarchy of steps in the method can be rearranged while remaining within the disclosed subject matter. The accompanying method claims present elements of the various steps in a sample order, and are not necessarily meant to be limited to the specific order or hierarchy presented.

The described disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form (e.g., software, processing application) readable by a machine (e.g., a computer). The machine-readable medium may include, but is not limited to, magnetic storage medium (e.g., floppy diskette), optical storage medium (e.g., CD-ROM); magneto-optical storage medium, read only memory (ROM); random access memory (RAM); erasable programmable memory (e.g., EPROM and EEPROM); flash memory; or other types of medium suitable for storing electronic instructions.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

While the present disclosure has been described with reference to various embodiments, it will be understood that these embodiments are illustrative and that the scope of the disclosure is not limited to them. Many variations, modifications, additions, and improvements are possible. More generally, embodiments in accordance with the present disclosure have been described in the context or particular embodiments. Functionality may be separated or combined in blocks differently in various embodiments of the disclosure or described with different terminology. These and other variations, modifications, additions, and improvements may fall within the scope of the disclosure as defined in the claims that follow.

We claim:

1. A method for developing and deploying applications, the method comprising:
executing a deployment environment on at least one computing device;
receiving a request at the deployment environment executing on the at least one computing device from at least one user to develop a software application within the deployment environment;
creating the software application utilizing the deployment environment executing on the at least one computing device based on input received by the deployment environment from the at least one user; and
deploying the created software application utilizing the deployment environment executing on the at least one computing device in response to a deployment indication received by the deployment environment from the at least one user.

2. The method of claim 1, wherein said operation of deploying the created software application comprises providing an automatically generated reference that can be utilized to access the created software application via the deployment environment.

3. The method of claim 2, wherein the reference comprises at least one of an iframe uniform resource locator or a uniform resource locator link.

4. The method of claim 2, further comprising:
receiving a request to access the created software application at the deployment environment executing on the at least one computing device, the request to access submitted via a web browser utilizing the reference; and
delivering access to the created software application, utilizing the deployment environment executing on the at least one computing device, in response to the request to access.

5. The method of claim 4, wherein said operation of delivering access to the created software application comprises:
executing the created software application utilizing the deployment environment executing on the at least one computing device;
transmitting output for the created software application from the deployment environment executing on the at least one computing device to the web browser; and
receiving input for the created software application at the deployment environment executing on the at least one computing device from the web browser.

6. The method of claim 1, wherein said operation of creating the software application utilizing the deployment environment executing on the at least one computing device based on input received by the deployment environment from the at least one user comprises:
providing a software application creation wizard that presents a series of prompts, guiding the at least one user through a default template for creating the software application;
receiving a plurality of responses from the at least one user in response to the series of prompts; and
creating the software application based at least on the plurality of responses.

7. The method of claim 1, wherein said operation of creating the software application utilizing the deployment environment executing on the at least one computing device based on input received by the deployment environment from the at least one user comprises:
providing a plurality of pre-assembled application components that the at least one user can select to construct the application;
receiving selections from the at least one user of one or more pre-assembled application components of the plurality of pre-assembled application components; and
creating the software application based at least on the selections.

8. The method of claim 7, further comprising:
receiving programming code from the at least one user; and
modifying at least one of the selections utilizing the programming code;
wherein the operation of creating the software application based at least on the selections creates the software application based on the modified at least one selection.

9. The method of claim 1, further comprising:
receiving a request to modify the created software application within the deployment environment after deployment;
modifying the created software application based at least on the request such that future accesses to the created software application access the modified software application.

10. The method of claim 1, wherein the at least one user submitted the deployment indication by selecting a single selection element associated with deployment of the software application.

11. A system for developing and deploying applications, the system comprising:
at least one non-transitory machine-readable storage medium operable to store instructions for implementing a deployment environment;
at least one processing unit operable to execute the deployment environment by executing the instructions stored in the at least one non-transitory machine-readable storage medium; and
at least one input/output component operable to receive and transmit communications for the deployment environment;
wherein the deployment environment receives a request via the at least one input/output component from at least one user to develop a software application within the deployment environment, creates the software application at least based on input received from the at least one user via the at least one input/output component, and deploys the created software application in response to a deployment indication received from the at least one user via the at least one input/output component by providing a reference that can be utilized to access the created software application via the deployment environment.

12. The system of claim 11, wherein the deployment environment is operable to modify the created software application subsequent deployment based on a request received via the at least one input/output such that subsequent accesses to the created software application access the modified software application.

13. The system of claim 11, wherein the deployment environment provides the at least one user a choice between a software application creation wizard that guides the at least one user through a default template for creating the software application and selection of a plurality of pre-assembled application components that the user can select to design the software application.

14. The system of claim 13, wherein the input received from the at least one user comprises selections of one or more pre-assembled application components of the plurality of pre-assembled application components.

15. The system of claim 14, wherein the deployment environment modifies the one or more pre-assembled application components utilizing programming code received from the at least one user via the at least one input/output component.

16. The system of claim 11, wherein the input received from the at least one user comprises responses to a series of prompts provided by the software application creation wizard.

17. The system of claim 11, wherein the deployment environment is operable to provide access to the created software application in response to a request for access received via the at least one input/output component from a web browser utilizing the reference.

18. The system of claim 17, wherein the deployment environment provides access to the created software application by executing the created software application, transmitting output for the created software application to the web browser via the at least one input/output component, and receiving input for the created software application from the web browser via the at least one input/output component.

19. The system of claim 11, wherein the reference comprises at least one of an iframe uniform resource locator or a uniform resource locator link.

20. A computer program product, comprising:
a first set of instructions, stored in at least one non-transitory machine-readable medium, executable by at least one processing unit to execute a deployment environment;
a second set of instructions, stored in the at least one non-transitory machine-readable medium, executable by the at least one processing unit to receive a request at the deployment environment from at least one user to develop a software application within the deployment environment;
a third set of instructions, stored in the at least one non-transitory machine-readable medium, executable by the at least one processing unit to create the software application utilizing the deployment environment based on input received by the deployment environment from the at least one user; and
a fourth set of instructions, stored in the at least one non-transitory machine-readable medium, executable by the at least one processing unit to deploy the created software application utilizing the deployment environment in response to a deployment indication received by the deployment environment from the at least one user.
